(19) United States
(12) Patent Application Publication
(10) Pub. No.: US 2015/0086398 A1
(43) Pub. Date: Mar. 26, 2015

(54) ROTOR FOR BRUSHLESS DC MOTOR AND BRUSHLESS DC MOTOR

(71) Applicant: Bleckmann GmbH & Co. KG, Lamprechtshausen (AT)

(72) Inventors: Gernot Teufl, Hallein (AT); Andreas Pleschinger, Schleedorf (AT)

(21) Appl. No.: 14/490,508

(22) Filed: Sep. 18, 2014

(30) Foreign Application Priority Data
Sep. 20, 2013 (EP) 13 185 451.5-1804

(51) Int. Cl. H02K 1/27; F04D 13/02; H02K 5/12; H02K 7/08; H02K 1/04

(52) U.S. Cl. CPC H02K 1/2733; H02K 7/083; H02K 1/04; H02K 5/12; F04D 13/024
USPC 417/423.7; 310/90; 310/43; 310/89

(57) ABSTRACT

A rotor unit for a brushless direct current motor (BLDC motor) comprises a main body integrally formed with a rotor shaft and an annular ring magnet mounted on the main body. The annular magnet comprises an anisotropic hard ferrite and is laterally magnetized. The rotary shaft and the main body of the rotor unit may be formed from one plastic material. The rotor unit is supported within the BLDC motor via self-lubricating bearing seats.

### BACKGROUND

1. Technical Field

The present invention relates to the field of brushless direct current electric motors, called BLDC motors, in particular for use in wet-running circulation pumps of home appliances, for example. In particular, the invention relates to a rotor unit for such a BLDC motor according to the preamble of independent claim 1.

2. Description of the Related Art

EP 1 841 041 A1 shows a BLDC motor for use in wet-running pumps. The BLDC motor has a permanently excited rotor which comprises a plastic connection between a reflux base and a rotor shaft. The plastic connection is formed by injection molding and provides for a fixed and watertight attachment of the reflux base to the rotor shaft. Furthermore, permanent magnets are attached to the reflux base via another plastic connection. Both plastic connections may be formed in the same injection molding process. Additionally, the rotor is provided with an injection molded plastic sheath enclosing the whole rotor and fixing the permanent magnets so that a moisture resistant and fluid resistant rotor for wet-running pumps is formed. The permanent magnets of such rotors are rare-earth magnets, for example neodymium iron boron (NdFeB) magnets, exhibiting a high magnetic remanence (usually more than 1.2 Tesla) and being able to be magnetized in a molded condition.

However, rare-earth materials are very expensive and suffer under shortage of resources. Moreover, the materials are susceptible to corrosion in aqueous dilutions so that it is necessary to completely coat and mold the magnets for preventing corrosion. As another disadvantage of the rotor of EP 1 841 041 A1, it is required to overmold the rotor components two times, namely once for the cage or reflux base and once for the outside overmolding to mount the individual magnet elements. Another disadvantage of the rotor shown in this document is that the stop disc of the bearing has to be mounted together with an o-seal in an additional production step.

EP 1 533 883 A1 shows another BLDC motor for use in wet-running pumps, such as pumps for dishwashers, having a permanent magnet rotor which comprises a laminated ferromagnetic core, a rotor shaft made of a magnetic stainless steel and emerging from opposite ends of the core, and a container casing made from stainless steel in which the core is positioned and from which the drive shaft emerges. At least one curved magnetic element is provided between the core and the inner wall the container casing. The core comprises deformable radial projections arranged to act on the opposing lateral ends of the at least one magnetic element so as to urge it radially towards the inner wall of the container casing. The at least one magnetic element is made from anisotropic ferrites, which is a cost-efficient material, wherein the magnetic element can be manufactured in a cost-effective sintering process to form anisotropic magnets.

However, anisotropic ferrites exhibit a relative low magnetic remanence (usually less than 0.5 Tesla), and magnetizing the core has to be performed in a sheathed condition with a magnetic gap to the magnetizing device resulting in a non-optimal utilization of material. Furthermore, the mounting process is laborious with respect to the core laminate for the magnetic reflux and with respect to sheathing and positioning of the magnet elements. This involves a lot of component parts, a stainless steel sheath (obtained by drawing) and seal elements.

Both conventional rotors described above are comprising a steel shaft which penetrates the outer sheath and the rotor. Usage of steel for the shaft represents a tradeoff between high hardness, abrasive wear and corrosion resistance in brine, so that the material characteristics of the rotor shaft are not optimal. This leads to wear of the rotor shaft resulting in slackness and acoustic emissions. Furthermore, the whole construction of these rotors in connection with the used materials results in magnetic and mechanic imbalances because of unavoidable tolerances during manufacturing. Thus, also the induction distribution is not ideal and deviates from a sinus shape resulting in increased torque variations and further acoustic emissions.

### BRIEF SUMMARY

It is an object of the invention to provide an improved rotor unit which is easier to produce and eliminates the above mentioned disadvantages of prior art. It is another object of the invention to provide a BLDC motor comprising such a rotor unit for use in home appliances, for example.

The object is solved according to the invention by a rotor for a BLDC motor as set forth in independent claim 1. Further developed embodiments of the invention are provided as set forth in the dependent claims.

According to a first aspect of the invention, in a first embodiment a rotor unit for a brushless direct current motor is provided, comprising a main body having a substantially cylindrical portion integrally formed with a rotor shaft, wherein the rotor shaft of the main body comprises first and second bearing portions, and an annular magnet mounted on the outer circumference of the cylindrical portion of the main body. Thus, a separate steel rotor shaft may be omitted, facilitating manufacturing of the BLDC motor and reducing weight and torque inertia of the motor. The BLDC motor having that novel rotor unit is easy to manufacture and is a cost-efficient device in particular for use in a wet-running pump mounted in home appliances, for example. However, other applications are feasible such as immerged pumps in industrial processes for pumping corrosive fluids.

In a further development of the invention, the annular magnet comprises an anisotropic hard ferrite, preferably strontium ferrite. Thus, the unsheathed rotor unit is suitable for coming in contact with drinking water or other corrosive fluids.

In another independent development of the invention the annular magnet is in positive locking engagement with the main body. Alternatively, the magnet may be fixed to the main body by bonding or force-locking techniques such as pressing.

In another independent development of the invention, the main body comprises a glass fiber reinforced (GFR) plastic material.

According to a further independent aspect of the invention, the main body comprises a functional plastic material, preferably an abrasive wear resistant plastic material. Furthermore, the first and second bearing portions may provide two cylindrical sliding surfaces. In this manner, even fewer components and a more simple manufacturing process are required while operating characteristics and service life of the BLDC motor may be further improved.

In a further development of the invention, the main body comprises an annular surface adjacent to one of the bearing portions and arranged to bear axial forces.

According to a second embodiment of the invention, the main body further comprises first and second bearing sleeves providing two cylindrical sliding surfaces an being respectively attached to the first and second bearing portions. The first and second bearing sleeves may comprise ceramic materials, preferably oxide ceramics or nitrides, or may comprise glass fiber reinforced plastics, preferably polypropylene or polybutylene terephthalate. Thus, good operating characteristics and a long service life are achieved using fewer components.

In a further development of the invention, one of the first and second bearing sleeves may comprise a collar protruding radially from the cylindrical portion of the bearing sleeve and being arranged to bear axial forces.

In another independent development of the above described embodiments of the invention the annular magnet is magnetized to have a plurality of laterally polarized alternating magnetic poles. In this manner, using an annular magnet having a cylindrical outer surface without gaps and providing for a lateral magnetization may provide for a magnetic flux distribution or an induction distribution along the rotary angle having a nearly ideal sinus shape. This results in less torque variations and acoustic emissions.

In further independent development of the invention the annular magnet may have a wall thickness and a magnetization coordinated to each other in such a manner that an emission of the magnetic field at an inner cylindrical surface of the annular magnet is minimized. In this manner, a core laminate may be omitted resulting in a BLDC motor having less weight and smaller dimensions.

According to another aspect of the invention a brushless direct current motor is provided which comprises a rotor unit according to the above mentioned first aspect of the invention, and further comprising a motor casing defining a rotor chamber receiving the rotor unit, wherein the motor casing has a central reception portion receiving a first bearing seat supporting the first bearing portion of the main body, and a casing plate mounted to the motor casing so as to cover an aperture of the rotor chamber, wherein the casing plate has a center hole receiving a second bearing seat supporting the second bearing portion of the main body.

In another independent development of the invention, the first and the second bearing seats may comprise a carbon material or a material containing graphite.

In another independent development of the invention, the first and the second bearing seats may comprise a self-lubricating functional material, preferably a bulk mold compound, more preferably a compound comprising at least one of polyphthalamide, aramide fibers, polytetrafluorethylene and graphite.

In a further independent development of the invention, one of the first and second bearing seats may comprise a collar portion arranged to bear axial forces and to restrict an axial movement of the main body of the rotor unit.

According to another independent aspect of the invention a wet-running pump, in particular for use in home appliances, comprising a brushless direct current motor according to one of the above mentioned aspects of the invention is provided.

### BRIEF DESCRIPTION OF THE SEVERAL VIEWS OF THE DRAWINGS

In the following, further advantages and embodiments of the inventive method and apparatus are described in conjunction with the attached drawings. Thereby, the expressions left, right, below and above are referred to the drawings in an orientation of the drawings which allows the normal reading of the reference numbers, but do not necessarily define a position or orientation of the features or components with respect to manufacturing or operation, unless explicitly stated.

FIG. 1 is a perspective sectional view of a BLDC motor comprising a rotor unit according to a first embodiment of the invention.

FIG. 2 is a perspective sectional view of a BLDC motor comprising a rotor unit according to a second embodiment of the invention.

FIG. 3 is a front view of the annular magnet showing the lateral magnetization of the annular magnet of the rotor unit according to the invention.

### DETAILED DESCRIPTION

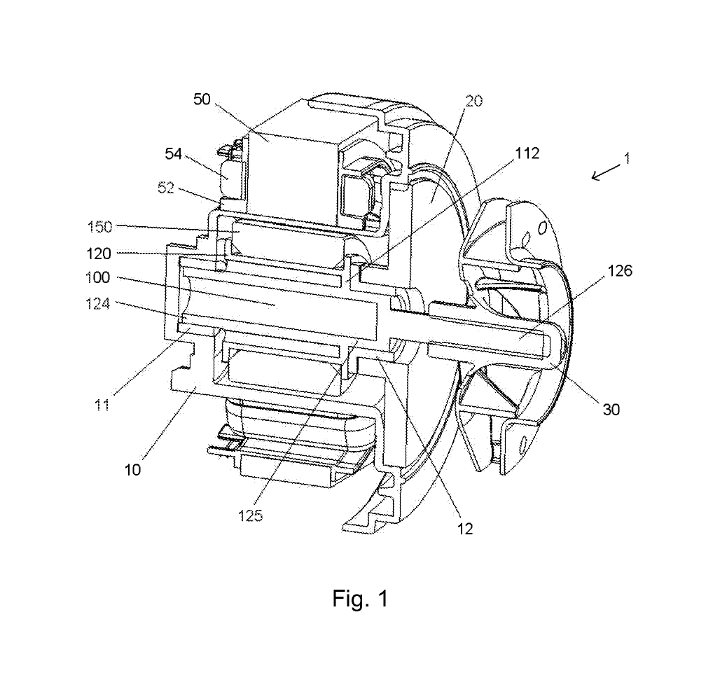

With respect to FIG. 1, a pump comprising a BLDC motor 1 having a rotor unit according to a first embodiment of the invention will be described in the following.

FIG. 1 shows a pump having a blade wheel 30 mounted on an output shaft portion 126 of a BLDC motor 1 according to the first embodiment of the invention. The electric BLDC motor 1 comprises a motor casing 10 preferably made of a plastic material such as glass fiber reinforced polypropylene (GR-PP) and defining a rotor chamber having a recess and an aperture for receiving a rotor unit. A stator mounted on the outer circumference of the rotor chamber of the motor casing 10 comprises, for example, a yoke assembly consisting of a laminated ferromagnetic yoke 50, at least one bobbin 52 and a plurality of coils 54 providing a plurality of stator poles. Electric power supply to a plurality of windings distributed over the coils 54 is commutated for generating a rotating magnetic field in a usual manner (for example by electronic commutation).

A first bearing seat 11 is provided at the bottom (opposite to the aperture) of the rotor chamber. A casing plate 20 is mounted at the aperture of the rotor chamber for covering the same. The casing plate has a center hole receiving a second bearing seat 12 which, in cooperation with the first bearing seat 11, rotationally supports by slide bearing the rotor unit arranged in the rotor chamber. The bearing seats 11, 12 preferably comprise a carbon material having good lubricating characteristics and a long service life. Alternatively, the bearing seats may comprise a wear resistant material containing graphite.

The rotor unit of the first embodiment shown in FIG. 1 comprises a main body 100 and an annular magnet 150. The main body 100 comprises a substantially cylindrical portion 120 integrally formed with a rotor shaft having first and second rotor shaft portions 124, 125, 126. The main body 100 preferably comprises a thermoplastic or a thermosetting non-magnetic material, preferably glass fiber reinforced plastics (GRP) such as glass fiber reinforced polypropylene (GR-PP).

As is further shown in FIG. 1, the main body 100 may comprise two coaxially arranged cylindrical portions having different diameters. The portion having the smaller diameter represents the rotor shaft, while the other cylindrical portion 120 having the larger diameter serves to receive on its outer circumference the annular magnet 150. In one embodiment, the cylindrical portions of the main body 100 are integrally formed (by injection molding, for example) and connected to each other via a front plate 112 at an axial end of the same and/or via a plurality of longitudinal webs extending between the two cylindrical portions in axial direction. The main body 100 may be formed as a massive body, too. The main body 100 may be injection molded within the pre-manufactured annular magnet 150 using the annular magnet 150 as a part of the injection mold. In this manner, a so called composite shaft is formed comprising a rotor shaft and a cylindrical portion receiving an annular magnet.

Furthermore, the rotor shaft portions 124, 125, 126 comprise bearing portions 124, 125 providing two cylindrical bearing surfaces or sliding surfaces, respectively. The first and second bearing portions 124, 125 of the main body 100 are supported in the respective first and second bearing seats 11, 12 as shown in FIG. 1. For achieving good operating characteristics and a long service life, the main body 100 may be formed as a component comprising a functional plastic material, preferably an abrasive wear resistant functional plastic material such as thermoplastic or a thermosetting non-magnetic material, preferably glass fiber reinforced plastics (GRP) such as glass fiber reinforced polypropylene (GR-PP) or the like. The first and second bearing seats 11, 12 may comprise another functional material such as highly filled and reinforced thermoplastic materials or bulk mold compounds (BMC). For example, a preferred compound material may comprise at least one of polyphthalamide, aramide fibers, polytetrafluorethylene and graphite as a lubricating component. Thus, the bearing seats are self-lubricating. It has to be noted that the bearing seats 11, 12 may alternatively comprise a carbon material or other materials containing graphite, as mentioned above. In this manner, an very simple construction is achieved comprising less components and exhibiting excellent characteristics. In particular, the components of the rotor unit are resistant to abrasive materials in the fluid to be pumped, resistant to cleaning agents and brines, and comply with migration limits for drinking water contact.

Furthermore, the base of the blade wheel 30 may be integrally formed with the protruding output shaft portion 126 of the main body 100. Moreover, as shown in FIG. 1, the second bearing seat 12 may have a collar which, in cooperation with an annular surface 112 of the main body 100 or of the cylindrical portion 120 of the main body 100 adjacent to one of the bearing portions 125, is configured to bear axial forces generated by the blade wheel 30. Thus, a separate stop disc is not necessary.

In a further development of the invention, the base of the blade wheel 30 may be formed integrally with an elongated protruding end 126 of the rotor shaft portion 125. Thus, a very simple and cost-effective manufacturing process, such as injection molding, can be used to manufacture the main body 100 in a structural unit with the rotor shaft. The cylindrical portion 120 carries the annular magnet 150.

With the first embodiment as described above, advantageous effects can be achieved. In particular, the number of components and the number of manufacturing steps are decreased and manufacturing is simplified. Moreover, machining of a separate rotor shaft, made of steel for example, can be eliminated, and furthermore, the weight and the rotary inertia of BLDC motor 1 are decreased.

In one embodiment, the annular magnet 150 is formed as one piece, preferably from an anisotropic hard ferrite such as strontium ferrite which is suitable for contact with tap water and has a relative high corrosion resistance. Also other permanent magnetic materials having a good corrosion resistance are suitable. Such anisotropic annular magnets can be manufactured in a very simple and cost-efficient manner, for example by a sintering process. Machining of the inner surface of the annular magnet 150 is not required. Furthermore, because of the high corrosion resistance of the used permanent magnetic material, no rotor sheath or casing covering the magnetic material is required, even if the rotor is floating in the fluid to be pumped, so that a rotor sheath may be omitted and the magnetic gap of the BLDC motor 1 between the annular magnet 150 of the rotor and the yoke 50 of the stator may be advantageously reduced. Another advantage is that the annular magnet 150 may be magnetized before or after assembling of the rotor unit and without any sheath covering the magnet, i.e., in direct contact with a magnetizing device. This results in an optimal utilization of the material.

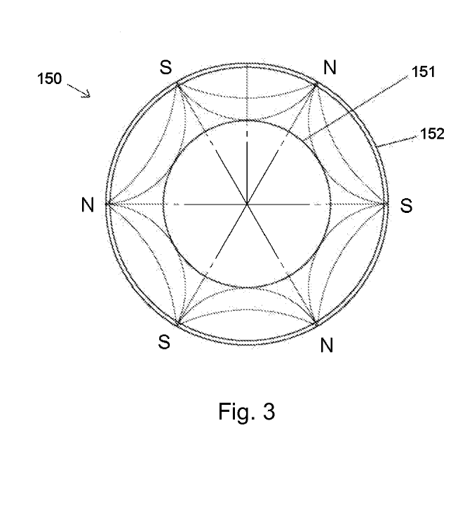

In the depicted exemplary configuration of a BLDC motor configured for applications with a typical power range of 70 to 100 W, the annular magnet 150 may be magnetized to have six alternating magnetic poles N and S, while the yoke assembly correspondingly comprises nine teeth (poles). Other numbers and ratios of poles may be used, too. In one embodiment, the poles of the annular magnet 150 are laterally polarized on the outer circumference 152 as is shown in FIG. 3. Other configurations are feasible, too, for example with higher or lower power or other dimensional proportions as depicted in the drawings. In a further development of the invention, the wall thickness and the magnetization of the annular magnet 150 may be coordinated in such a manner that an emission of the magnetic field at the back side 151 facing away from the stator (i.e., at the inner cylindrical surface 151 of the annular magnet 150) is minimized so that a core laminate improving the magnetic circuit may be omitted. Thus, the construction of the rotor unit is simplified and the rotor is reduced in size and weight. The wall thickness of the annular magnet preferably may be in the range of 3 to 10 mm, more preferably in the range of 5 to 7 mm.

In particular, this embodiment is advantageous in that the magnetic flux distribution, and thus the induction distribution along the rotary angle in a BLDC motor 1 according to this embodiment is very regular and close to an ideal sinus shape. Therefore, acoustic emissions and torque variations are reduced to very low levels.

Furthermore, also mechanical imbalances may be minimized because the outer surface of the rotor unit (the outer surface of the annular magnet 150) may be smoothed, while the balancing may be performed at the main body 100.

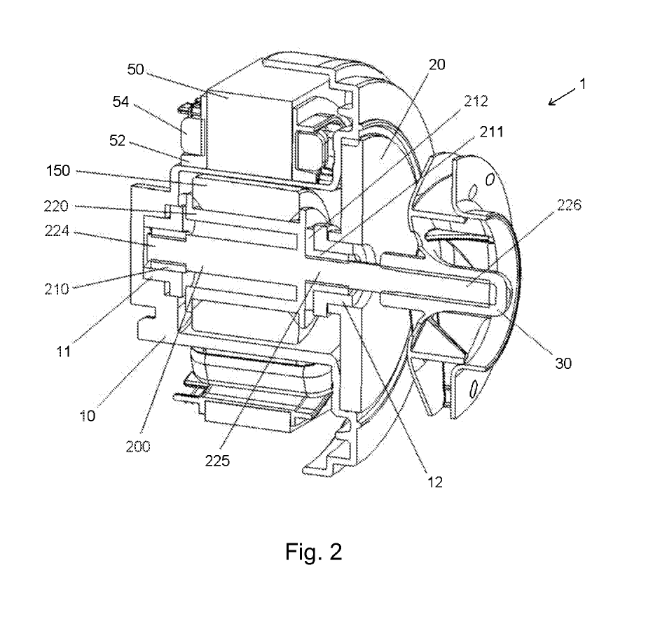

With respect to FIG. 2, a pump similar to that shown in FIG. 1, but comprising a BLDC motor 1 with a rotor unit according to a second embodiment of the invention will be described in the following. Components which are identical or very similar to that of the first embodiment are designated with the same reference numbers while a detailed description of the same is omitted.

The second embodiment shown in FIG. 2 comprises a rotor unit having a main body 200 which is integrally formed with a substantially cylindrical portion 220 and two rotor shaft portions 224, 225, 226, similar to the first embodiment shown in FIG. 1. The main body 200 may be formed as one component, preferably made of a functional plastic material.

The rotor shaft portions protrude from both sides of the cylindrical portion 220 and comprise first and second bearing portions 224, 225. The first bearing portion 224 of the main body 200 protruding to the bottom side of the motor casing 10 is provided with a fixedly attached first bearing sleeve 210. The second bearing portion 225 of the main body 200 protruding to the blade wheel side of the motor casing 10 is provided with a fixedly attached second bearing sleeve 211. The first and the second bearing sleeves 210, 211 preferably comprise ceramic materials or glass fiber reinforced plastics. Suitable ceramic materials are oxide ceramics or nitrides, for example. Suitable glass fiber reinforced plastics are polypropylene (PP) or polybutylene terephthalate (PBT), for example. The bearing sleeves 210, 211 are fixedly attached or integrated to the bearing portions 224, 225 of the main body 200 of the rotor unit. This connection is provided by a positive locking engagement or by injection molding or overmolding, i.e., molding the plastic material of the main body 200 around the pre-manufactured bearing sleeves 210, 211. In this manner, a composite shaft is formed in which the bearing surfaces or sliding surfaces, which are supported in corresponding bearing seats 11, 12 arranged at the motor casing 10 and the casing plate 20, are provided in the form of integrated ceramic components 210, 211.

The second bearing sleeve 211 may have a collar 212 serving as an integrated stop disc portion protruding radially from the cylindrical sleeve portion of the bearing sleeve 211 as shown in FIG. 2. This collar 212 may abut on a front plate of the main body 220 and restrict axial movement of the rotor unit 200 in cooperation with a corresponding collar portion of the second bearing seat 12 received in the center hole of the casing plate 20, in order to bear axial forces generated by the blade wheel 30. Thus, a separate stop disc may be omitted.

In a further development of the second embodiment, the base of the blade wheel 30 may be formed integrally with an elongated protruding end (output shaft portion) 226 of the rotor shaft portion 225.

With the second embodiment as described above, the advantageous effects of the first embodiment as mentioned above may be achieved and even further improved. In particular, the combination of bearing materials, i.e., the ceramic material of the bearing sleeves 210, 211 and the carbon material of the bearing seats 11, 12, provide for very good operating characteristics and a long service life of the BLDC motor 1.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A rotor unit for a brushless direct current motor, in particular for use in a wet-running pump, comprising:
a main body having a substantially cylindrical portion integrally formed with a rotor shaft,
wherein the rotor shaft of the main body comprises first and second bearing portions; and
an annular magnet mounted on the outer circumference of the cylindrical portion of the main body.

2. The rotor unit according to claim 1,
wherein the main body comprises a glass fiber reinforced plastic material.

3. The rotor unit according to claim 1,
wherein the main body comprises a plastic material.

4. The rotor unit according to claim 1,
wherein the first and second bearing portions provide two cylindrical sliding surfaces.

5. The rotor unit according to claim 4,
wherein the main body comprises an annular surface adjacent to one of the bearing portions and arranged to bear axial forces.

6. The rotor unit according to claim 1,
further comprising first and second bearing sleeves providing two cylindrical sliding surfaces and being respectively attached to the first and second bearing portions.

7. The rotor unit according to claim 6,
wherein the first and second bearing sleeves comprise a ceramic material or comprise glass fiber reinforced plastics.

8. The rotor unit according to claim 6,
wherein one of the first and second bearing sleeves comprises a collar protruding radially from the cylindrical portion of the bearing sleeve and being arranged to bear axial forces.

9. The rotor unit according to claim 1,
wherein the annular magnet is magnetized to have a plurality of laterally polarized alternating magnetic poles.

10. The rotor unit according to claim 9,
wherein the annular magnet has a wall thickness and a magnetization coordinated to each other in such a manner that an emission of the magnetic field at an inner cylindrical surface of the annular magnet is minimized.

11. A brushless direct current motor comprising a rotor unit according to one of the preceding claims, and further comprising
a motor casing defining a rotor chamber receiving the rotor unit, wherein the motor casing has a central reception portion receiving a first bearing seat supporting the first bearing portion of the main body, and
a casing plate mounted to the motor casing so as to cover an aperture of the rotor chamber, wherein the casing plate has a center hole receiving a second bearing seat supporting the second bearing portion of the main body.

12. The brushless direct current motor according to claim 11,
wherein the first and the second bearing seats comprise a carbon material or a material containing graphite.

13. The brushless direct current motor according to claim 11,
wherein the first and second bearing seats comprise a self-lubricating material.

14. The brushless direct current motor according to claim 11,
wherein one of the first and second bearing seats comprises a collar portion arranged to bear axial forces and to restrict an axial movement of the main body of the rotor unit.

15. A wet-running pump comprising a brushless direct current motor according to claim 11.

16. The rotor unit according to claim 1, wherein the main body comprises an abrasive wear resistant plastic material.

17. The rotor unit according to claim 6, wherein the first and second bearing sleeves comprise oxide ceramics or nitrides.

18. The rotor unit according to claim 6, wherein the first and second bearing sleeves comprise polypropylene or polybutylene terephthalate.

19. The brushless direct current motor according to claim 11, wherein the first and second bearing seats comprise a bulk mold compound.

20. The brushless direct current motor according to claim 11, wherein the first and second bearing seats comprise a compound selected from the group consisting of at least one of polyphthalamide, aramide fibers, polytetrafluorethylene and graphite.
